(19) United States
(12) Patent Application Publication
(10) Pub. No.: US 2025/0306410 A1
(43) Pub. Date: Oct. 2, 2025

(54) BACKLIGHT MODULE AND DISPLAY DEVICE

(71) Applicant: Coretronic Corporation, Hsin-Chu (TW)

(72) Inventors: Tzeng-Ke Shiau, Hsin-Chu (TW); Ying-Shun Syu, Hsin-Chu (TW)

(73) Assignee: Coretronic Corporation, Hsin-Chu (TW)

(21) Appl. No.: 19/095,041

(22) Filed: Mar. 31, 2025

Related U.S. Application Data
(60) Provisional application No. 63/572,378, filed on Apr. 1, 2024.

(30) Foreign Application Priority Data
Jul. 2, 2024 (CN) 202410876337.2

(51) Int. Cl. G02F 1/13; F21V 8/00; G02F 1/13357

(52) U.S. Cl. CPC G02F 1/1323; G02B 6/0036; G02F 1/133615

(57) ABSTRACT

A backlight module includes first and second light source modules, and a light guide module including a light guide plate and a viewing angle control unit. The light guide plate has multiple first and second microstructures, first and second light incident surfaces, a light exit surface, and a bottom surface. An angle between the first and second light incident surfaces is greater than or equal to 60 degrees and less than or equal to 120 degrees. The viewing angle control unit is at least disposed on the light exit surface and the bottom surface and adjacent to the first light source module or disposed between the first light incident surface and the first light source module. A first reflective surface and the bottom surface of each first microstructure have a first included angle. A second reflective surface and the bottom surface of each second microstructure has a second included angle.

### CROSS-REFERENCE TO RELATED APPLICATION

This application claims the priority benefits of U.S. provisional application Ser. No. 63/572,378, filed on Apr. 1, 2024, and China application serial no. 202410876337.2, filed on Jul. 2, 2024. The entirety of each of the above-mentioned patent applications is hereby incorporated by reference herein and made a part of this specification.

### BACKGROUND

### Technical Field

The disclosure relates to an optical module and an optical device, and particularly relates to a backlight module and a display device.

### Description of Related Art

Generally, a display device with an anti-peeping function is mainly provided with a switchable viewing angle control device on the optical path of the illumination beam of the backlight module, so that the display device can be switched between an anti-peeping mode and a sharing mode. However, currently, the switchable viewing angle control device has to be used with a light-collecting backlight module or a general backlight module with a louver film to achieve a good anti-peeping effect.

However, the above display device still has the following disadvantages. Firstly, the switchable viewing angle control device increases the thickness and weight of the display device and increases the cost. Secondly, in the sharing mode, the light output viewing angle thereof is still smaller than a general display device, which leads to poor user experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

To achieve one, part, or all of the above purposes or other purposes, an embodiment of the disclosure provides a backlight module of the disclosure includes a first light source module, a second light source module, and a light guide module. The light guide module includes a light guide plate and a viewing angle control unit. The light guide plate has a plurality of first microstructures, a plurality of second microstructures, a first light incident surface, a second light incident surface, a light exit surface, and a bottom surface, in which the light exit surface is opposite to the bottom surface. The first light source module is disposed corresponding to the first light incident surface, and the second light source module is disposed corresponding to the second light incident surface. An included angle between the first light incident surface and the second light incident surface is greater than or equal to 60 degrees and less than or equal to 120 degrees. The viewing angle control unit is at least disposed on the light exit surface and the bottom surface of the light guide plate and is adjacent to the first light source module or is disposed between the first light incident surface and the first light source module. A first reflective surface of each first microstructure faces the first light incident surface. A second reflective surface of each second microstructure faces the second light incident surface. The first reflective surface and the bottom surface have a first included angle. The second reflective surface and the bottom surface have a second included angle. The first included angle is not equal to the second included angle.

To achieve one, part, or all of the above purposes or other purposes, an embodiment of the disclosure provides a display device, which includes the above backlight module and a display panel. The display panel is disposed on the backlight module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a display device according to an embodiment of the disclosure.

FIG. 2 is a schematic top view of a backlight module in FIG. 1.

FIG. 3 is a schematic view of a first microstructure and a second microstructure of the backlight module in FIG. 1.

FIG. 4 is a schematic view of the backlight module according to the first embodiment of the disclosure.

FIG. 5 is a schematic view of a light shape of a beam emitted from a first light source module after emitting light from a light exit surface of the backlight module according to an embodiment of the disclosure.

FIG. 6 is a schematic view of a light shape of a beam emitted from a second light source module after emitting light from the light exit surface of the backlight module according to an embodiment of the disclosure.

FIG. 7 is a schematic view of the backlight module according to the second embodiment of the disclosure.

FIG. 8 is a schematic view of the backlight module according to the third embodiment of the disclosure.

FIG. 9 is a schematic view of the backlight module according to the fourth embodiment of the disclosure.

FIG. 10 is a schematic view of the backlight module according to the fifth embodiment of the disclosure.

FIG. 11 is a schematic view of the backlight module according to the sixth embodiment of the disclosure.

FIG. 12 is a schematic view of the backlight module according to the seventh embodiment of the disclosure.

FIG. 13 is a schematic view of the backlight module according to the eighth embodiment of the disclosure.

FIG. 14 is a schematic view of the backlight module according to a ninth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a backlight module and a display device, which can produce the effect of switchable viewing angles under the design of low system thickness and weight, and can provide a larger light output angle in a sharing mode.

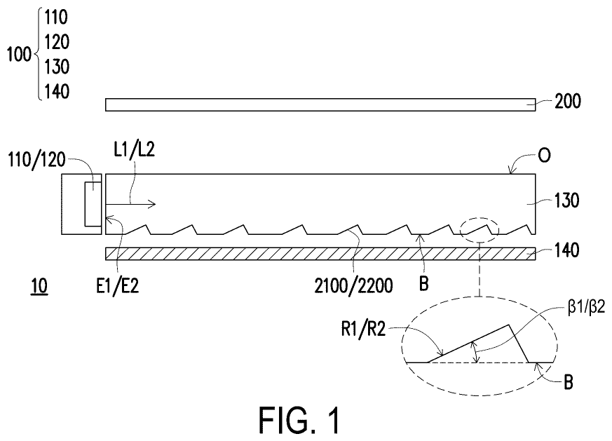

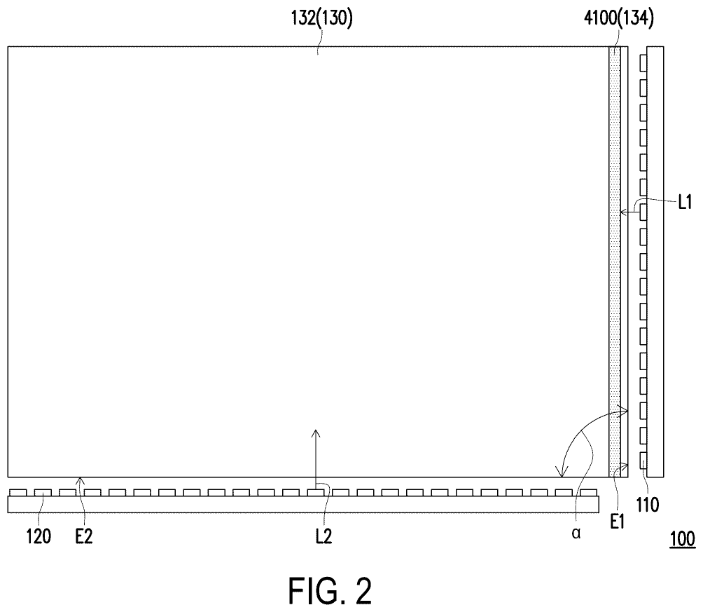

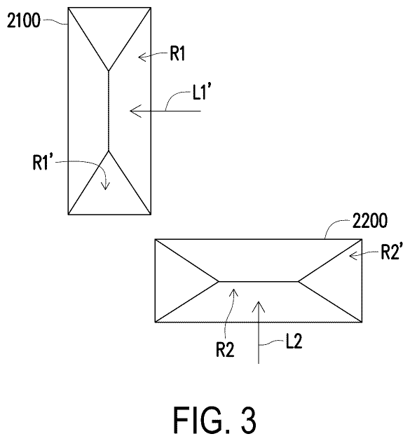

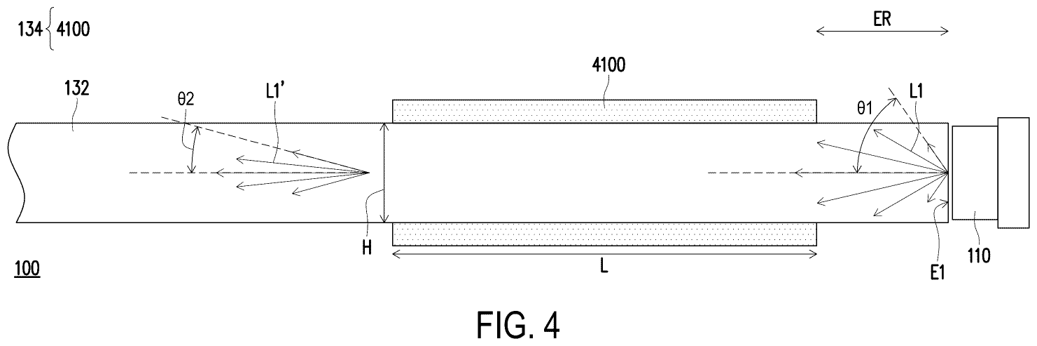

FIG. 1 is a schematic view of a display device according to an embodiment of the disclosure. FIG. 2 is a schematic top view of a backlight module in FIG. 1. FIG. 3 is a schematic view of a first microstructure and a second microstructure of the backlight module in FIG. 1. FIG. 4 is a schematic view of the backlight module according to the first embodiment of the disclosure. Referring to FIG. 1 to FIG. 4, an embodiment of the disclosure provides a display device 10, which includes a backlight module 100 and a display panel 200. The display panel 200 is disposed on the backlight module 100. The display panel 200 is, for example, a liquid crystal display panel or other non-self-luminous display panels, but the disclosure is not limited thereto.

In this embodiment, the backlight module 100 includes a first light source module 110, a second light source module 120, and a light guide module 130. The light guide module 130 includes a light guide plate 132 and a viewing angle control unit 134. The light guide plate 132 has a plurality of first microstructures 2100, a plurality of second microstructures 2200, a first light incident surface E1, a second light incident surface E2, a light exit surface O, and a bottom surface B. The light exit surface O is opposite to the bottom surface B. The bottom surface B (the light exit surface O) connects the first light incident surface E1 and the second light incident surface E2, for example.

In this embodiment, the first light source module 110 is disposed corresponding to the

first light incident surface E1, and the second light source module 120 is disposed corresponding to the second light incident surface E2. The first light source module 110 and the second light source module 120 may be formed by a plurality of light sources, and the light sources may be light emitting diodes, sub-millimeter light emitting diodes, or micro light emitting diodes, but the disclosure is not limited thereto. The first light source module 110 is configured to emit a first beam L1, and the second light source module 120 is configured to emit a second beam L2. After entering the light guide plate 132, the first beam L1 and the second beam L2 are transmitted in the light guide plate 132. In the embodiment, the backlight module 100 may optionally include a reflector 140, and the light guide plate 132 is disposed between the reflector 140 and the display panel 200. The reflector 140 is configured to reflect/redirect the light emitted from the bottom surface B of the light guide plate 132 and transmit the light back to the light guide plate 132. In another embodiment, the backlight module 100 may optionally dispose (for example, coating or applying a film) a reflective layer on the bottom surface B of the light guide plate 132 to be configured to reflect the light transmitted to the bottom surface B.

In this embodiment, an included angle α between the first light incident surface E1 and the second light incident surface E2 is greater than or equal to 60 degrees and less than or equal to 120 degrees, for example, 90 degrees.

In this embodiment, as shown in FIG. 1 and FIG. 3, the first microstructure 2100 and the second microstructure 2200 are disposed on the bottom surface B, and a first reflective surface R1 of each first microstructure 2100 faces the first light incident surface E1 (for example, an included angle between a boundary line between the first reflective surface R1 and the bottom surface B and the first light incident surface E1 is less than 15 degrees). A second reflective surface R2 of each second microstructure 2200 faces the second light incident surface E2 (for example, an included angle between a boundary line between the second reflective surface R2 and the bottom surface B and the second light incident surface E2 is less than 15 degrees). The first reflective surface R1 is, for example, a plane, and the first reflective surface R1 and the bottom surface B have a first included angle B1. The second reflective surface R2 is, for example, a plane, and the second reflective surface R2 and the bottom surface B have a second included angle β2. The first included angle β1 is not equal to the second included angle B2. In an embodiment, the first included angle β1 is, for example, greater than or equal to 35 degrees and less than or equal to 55 degrees, and the second included angle β2 is, for example, greater than or equal to 20 degrees and less than or equal to 30 degrees, or greater than or equal to 65 degrees and less than or equal to 75 degrees. In a preferred embodiment, the first included angle β1 is equal to 45 degrees. The first included angle β1 and the second included angle β2 are used, for example, to respectively adjust the directions of the main beams (maximum brightness) of the light shapes of the first beam L1 and the second beam L2 exiting through the light exit surface O. For example, in an embodiment, when two orthogonal prism plates (the prism extension direction of the prism plate farther away from the light guide plate 132 is, for example, parallel to the second light incident surface E2, but not limited thereto) or inverse prism plate (the prism extension direction of the inverse prism plate is, for example, parallel to the second light incident surface E2, but not limited thereto) are arranged on a side of the light exit surface O of the light guide plate 132 (or a plurality of prism plates are disposed), both the first beam L1 and the second beam L2 can be directed close to the forward light output direction. In other embodiments, for example, when the first beam L1 or the second beam L2 needs to be directed in the same or different specific directions, the first included angle β1 may be equal to the second included angle β2.

In this embodiment, each first microstructure 2100 further includes a first side reflective surface R1′, and the first side reflective surface R1′ faces the second light incident surface E2. Each second microstructure 2200 further includes a second side reflective surface R2′, and the second side reflective surface R2′ faces the first light incident surface E1. The first side reflective surface R1′ and the bottom surface B have a third included angle. The second side reflective surface R2′ and the bottom surface B have a fourth included angle. The difference between the fourth included angle and the first included angle β1 is less than ±5 degrees, and the difference between the third included angle and the second included angle β2 is less than ±5 degrees. In a preferred embodiment, the third included angle is equal to the second included angle β2, and the fourth included angle is equal to the first included angle β1.

In this embodiment, the viewing angle control unit 134 is disposed on the light guide plate 132 and adjacent to the first light source module 110, as shown in FIG. 2 and FIG. 4. A projection area of the viewing angle control unit 134 on the light exit surface O is a first projection area, a display area of the display panel 200 (not shown in the drawing, for example, the area where the display panel 200 displays the image) on the light exit surface O is a second projection area, and the first projection area and the second projection area, for example, do not overlap (that is, there is a gap between the two projection areas), and the first projection area is, for example, located between the second projection area and the first light source module 110. In an embodiment, the first projection area does not overlap with projection areas of the first microstructure 2100 and the second microstructure 2200 on the light exit surface O.

In this embodiment, the viewing angle control unit 134 is disposed on the light exit surface O and the bottom surface B of the light guide plate 132, and the viewing angle control unit 134 includes a light absorption layer 4100. The material of the light absorption layer 4100 is, for example, a light absorbing material with a light absorption rate greater than 90%, and most of the light transmitted to the light absorption layer 4100 is absorbed by the light absorption layer 4100. A ratio (H/L) of a thickness H of the light guide plate 132 (thickness of the light guide plate 132 in a direction perpendicular to the bottom surface B) to a width L of the light absorption layer 4100 (width of the light absorption layer 4100 in a direction perpendicular to the first light incident surface E1) is less than or equal to 0.5 or 0.4. In the embodiment, the light guide plate 132 has an empty region ER between the light absorption layer 4100 and the first light source module 110.

That is to say, the empty region ER and the light absorption layer 4100 are non-optically effective areas of the display device 10 or the backlight module 100. In an embodiment, in the direction perpendicular to the first light incident surface E1, the width of the empty region ER is less than twice the width L of the light absorption layer 4100. In other embodiments, the edge of the light absorption layer 4100 may be flush with the first light incident surface E1, which means that there is no empty region ER. In an embodiment, the widths of the light guide plate 132 and the light absorption layer 4100 (the viewing angle control unit 134) in a direction perpendicular to the second light incident surface E2 are, for example, the same (or greater than 90%), as shown in FIG. 2.

In an anti-peeping mode of this embodiment, the second light source module 120 does not emit a beam, and the first beam L1 is emitted from the first light source module 110 and enters the light guide plate 132 via the first light incident surface E1 and is transmitted in the light guide plate 132. A portion beam L1′ of the first beam L1 passes through the section of the light guide plate 132 between the light absorption layer 4100 and continues to transmit in the light guide plate 132, while another portion of the first beam L1 is absorbed by the light absorption layer 4100. Further, the divergence angle of the first beam L1 after emitting from the first light source module 110 is θ1 (for example, half of the half-height width of the light distribution), and the divergence angle of the portion beam L1′ of the first beam L1 after passing through the section of the light guide plate 132 between the light absorption layer 4100 is θ2. The portion beam L1′ of the first beam L1 is transmitted to the first reflective surface R1 of the first microstructure 2100 or the second side reflective surface R2′ of the second microstructure 2200, then reflected by the first reflective surface R1 or the second side reflective surface R2′ to the light exit surface O, and then emitted from the light exit surface O. In the embodiment, the divergence angle θ2<the divergence angle θ1. Therefore, the viewing angle control unit 134/the light absorption layer 4100 effectively reduces the divergence angle of the first beam L1, so that the backlight module 100 has the effect of reducing the light emission range (for example, the half-height width of the light emission), so that the display device 10 has an anti-peeping function.

In the sharing mode of the embodiment, the second beam L2 is emitted from the second light source module 120 and then enters the light guide plate 132 and is transmitted in the light guide plate 132. The second beam L2 is transmitted to the second reflective surface R2 of the second microstructure 2200 or the first side reflective surface R1′ of the first microstructure 2100, then reflected to the light exit surface O, and then emitted from the light exit surface O. Therefore, the divergence angle of the second beam L2 remains substantially unchanged during the transmission process, which forms the sharing mode of the display device 10. In the sharing mode of this embodiment, the first light source module 110 may optionally emit or not emit a beam.

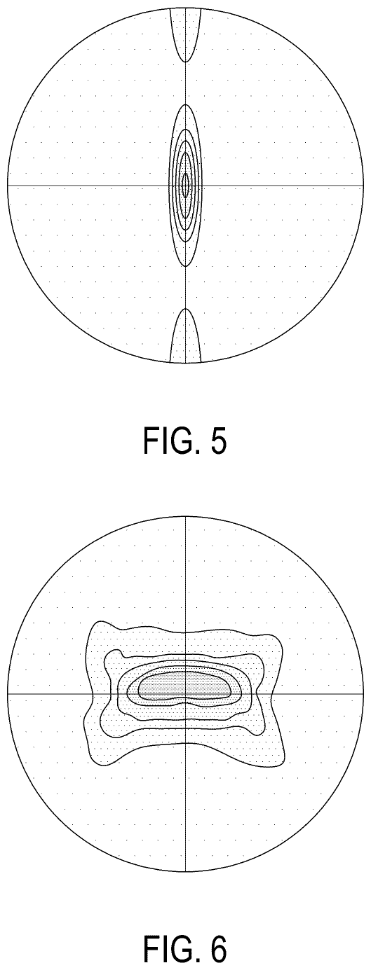

FIG. 5 is a schematic view of a light shape of a beam emitted from the first light source module after emitting light from a light exit surface of the backlight module according to an embodiment of the disclosure. FIG. 6 is a schematic view of a light shape of a beam emitted from the second light source module after emitting light from the light exit surface of the backlight module according to an embodiment of the disclosure. Referring to FIG. 5 and FIG. 6, based on the above, in the backlight module 100 and the display device 10 using the backlight module 100 according to an embodiment of the disclosure, the backlight module 100 includes the first light source module 110, the second light source module 120, and the light guide module 130. The light guide module 130 includes the light guide plate 132 and the viewing angle control unit 134. The viewing angle control unit 134 is disposed on the light guide plate 132 and adjacent to the first light source module 110. Therefore, when the system is in the sharing mode, the second light source module 120 is turned on (in another embodiment, the first light source module 110 and the second light source module 120 are turned on at the same time), and the divergence angle of the beam emitted by the second light source module 120 remains substantially unchanged during the transmission process. Therefore, as shown in FIG. 6, the light shape of the beam after emitting light from the light exit surface of the backlight module 100 has a wider light emission range in the first axial direction (for example, horizontal viewing angle), and the first axial direction is, for example, perpendicular to the first light incident surface E1. In contrast, when the system is in the anti-peeping mode, only the first light source module 110 is turned on, and the divergence angle of the beam emitted by the first light source module 110 is effectively reduced by the viewing angle control unit 134. Therefore, as shown in FIG. 5, the light shape of the beam after emitting light from the light exit surface of the backlight module 100 has a narrower light emission range in the first axial direction. In an embodiment, when the backlight module 100 is in the sharing mode, the light shape has a first half-height width (for example, in the first axial direction); when the backlight module 100 is in the anti-peeping mode, the light shape has a second half-height width (for example, in the first axial direction), and the ratio of the second half-height width to the first half-height width is, for example, less than or equal to ¾ (for example, ⅙, as shown in FIG. 5 and FIG. 6). Moreover, the light guide plate 132 has the plurality of first microstructures 2100 and the plurality of second microstructures 2200, the first reflective surface R1 of the first microstructure 2100 and the bottom surface B of the light guide plate 132 have the first included angle β1, and the backlight module 100 is designed such that the first included angle β1 is greater than or equal to 35 degrees and less than or equal to 55 degrees. Therefore, as shown in FIG. 5, in the anti-peeping mode, the light energy of the system can be maintained in the central area of the viewing angle. In this way, the backlight module 100/display device 10 can produce the effect of switchable viewing angles under the design of low system thickness and weight. Furthermore, the main beam emitted from the second light source module 120 is not transmitted to the viewing angle control unit 134 during the transmission process, so that the light output angle of the system is larger in the sharing mode, thereby a better experience is provided for the viewer.

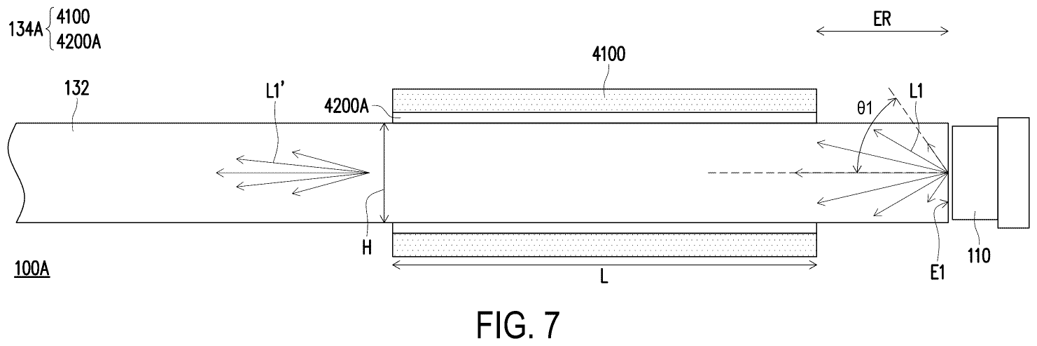

FIG. 7 is a schematic view of the backlight module according to the second embodiment of the disclosure. Referring to FIG. 7, a backlight module 100A is similar to the backlight module 100 in FIG. 4, and the main difference thereof is that in this embodiment, a viewing angle control unit 134A includes the light absorption layer 4100 and a light transmissive layer 4200A. The light transmissive layer 4200A is, for example, a transparent adhesive layer, but the disclosure is not limited thereto. The light transmissive layer 4200A is disposed between the light absorption layer 4100 and the light guide plate 132. In the embodiment, 0≤the refractive index of the light guide plate 132—the refractive index of the light transmissive layer 4200A≤0.4 or 0.3 is satisfied. By disposing the light transmissive layer 4200A and designing the refractive index of the light transmissive layer 4200A, part of the beam transmitted to the surface of the light transmissive layer 4200A may be selectively totally reflected and then continue to be transmitted within the light guide plate 132, while another part of the beam is transmitted to the light absorption layer 4100 and absorbed.

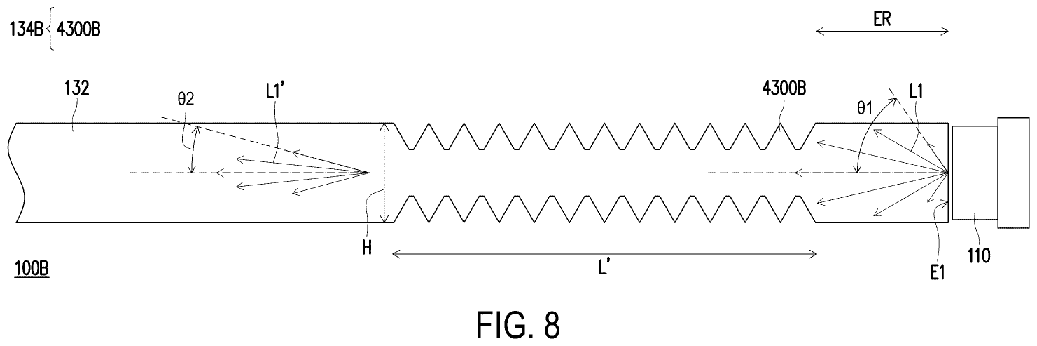

FIG. 8 is a schematic view of the backlight module according to the third embodiment of the disclosure. Referring to FIG. 8, a backlight module 100B is similar to the backlight module 100 in FIG. 4, and the main difference thereof is that in this embodiment, a viewing angle control unit 134B includes a plurality of microstructures 4300B. Each microstructure 4300B is formed in a prism shape. The cross section of each microstructure 4300B is, for example, a triangle, and each microstructure 4300B extends in a direction parallel to the first light incident surface E1. In the embodiment, the ratio of the thickness H of the light guide plate 132 to an arrangement width L′ of the plurality of microstructures 4300B on the light guide plate 132 is less than or equal to 0.5 or 0.4. In a preferred embodiment, the viewing angle control unit 134B further includes a light absorption layer as shown in FIG. 4, and the light absorption layer is disposed on the microstructure 4300B, which can effectively reduce the stray light of the system.

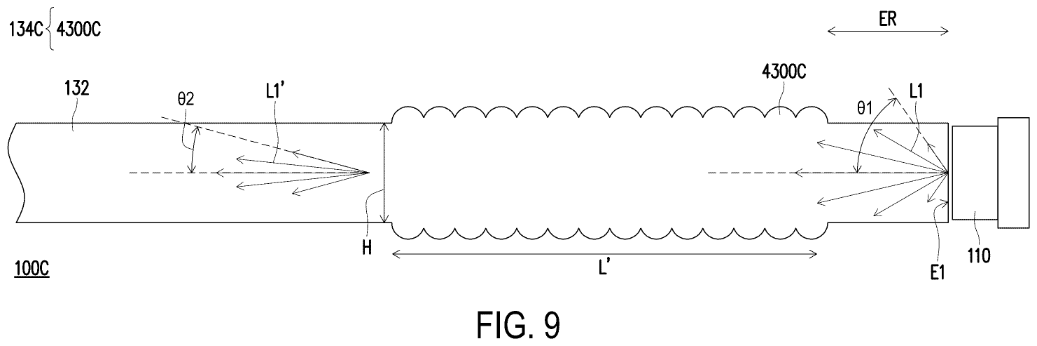

FIG. 9 is a schematic view of the backlight module according to the fourth embodiment of the disclosure. Referring to FIG. 9, a backlight module 100C is similar to the backlight module 100B in FIG. 8, and the main difference thereof is that in this embodiment, a microstructure 4300C of a viewing angle control unit 134C is formed in a semi-cylindrical shape. In a preferred embodiment, the viewing angle control unit 134C further includes a light absorption layer as shown in FIG. 4, and the light absorption layer is disposed on the microstructure 4300C, which can effectively reduce the stray light of the system.

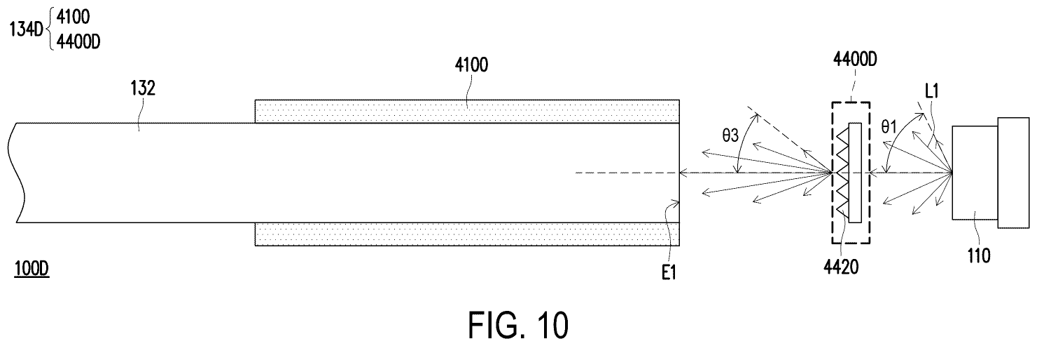

FIG. 10 is a schematic view of the backlight module according to the fifth embodiment of the disclosure. Referring to FIG. 10, a backlight module 100D is similar to the backlight module 100 in FIG. 4, and the main difference thereof is that in this embodiment, a viewing angle control unit 134D further includes a collimator 4400D. The collimator 4400D is disposed between the first light source module 110 and the light guide plate 132, that is, the viewing angle control unit 134D is disposed on the light guide plate 132 and is adjacent to the first light source module 110 and is disposed between the first light source module 110 and the light guide plate 132. For example, the widths of the collimator 4400D and the light guide plate 132 (or the first light source module 110) in the direction perpendicular to the second light incident surface E2 are the same (or greater than 90%). The collimator 4400D includes multiple first prism structures 4420. The apex of the first prism structure 4420 faces toward or faces away from the first light incident surface E1 (the first prism structure 4420 is arranged on a side surface of the collimator 4400D facing toward or facing away from the first light incident surface E1). In the embodiment, the first prism structure 4420 extends in a direction parallel to the first light incident surface E1, and the extending direction of the first prism structure 4420 is, for example, parallel to or perpendicular to an arrangement direction of multiple light sources of the first light source module 110. In an embodiment, the first prism structure 4420 extends in a direction parallel to the first light incident surface E1 and the light exit surface O. In addition, a divergence angle θ3 of the first beam L1 after passing through the collimator 4400D<the divergence angle θ1. In this way, a light collecting effect can be generated before the first beam L1 is transmitted to the light guide plate 132, and the incident angle range of the first beam L1 entering the first light incident surface E1 can be reduced, thereby the loss of light energy is reduced.

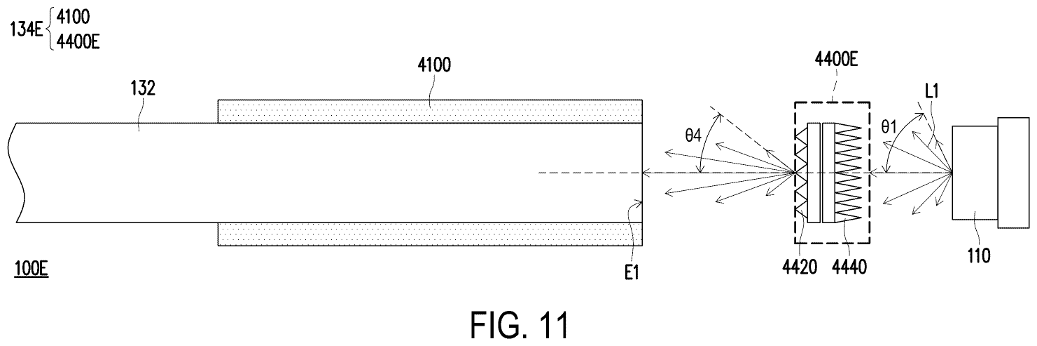

FIG. 11 is a schematic view of the backlight module according to the sixth embodiment of the disclosure. Referring to FIG. 11, a backlight module 100E is similar to the backlight module 100D in FIG. 10, and the main difference thereof is that in this embodiment, a collimator 4400E of a viewing angle control unit 134E includes the plurality of first prism structures 4420 and a plurality of second prism structures 4400. The apex of the first prism structure 4420 faces away from the apex of the second prism structure 4440. In the embodiment, the first prism structure 4420 and the second prism structure 4440 extend in a direction parallel to the first light incident surface E1, and the extending directions of the first prism structure 4420 and the second prism structure 4440 are respectively parallel to or perpendicular to the arrangement direction of the multiple light sources of the first light source module 110. In an embodiment, the first prism structure 4420 and the second prism structure 4440 extend in a direction parallel to the first light incident surface E1 and the light exit surface O. In addition, a divergence angle θ4 of the first beam L1 after passing through the collimator 4400E<the divergence angle θ1. In this way, a light collecting effect can be generated before the first beam L1 is transmitted to the light guide plate 132, and the incident angle range of the first beam L1 entering the first light incident surface E1 can be reduced, thereby the loss of light energy is reduced.

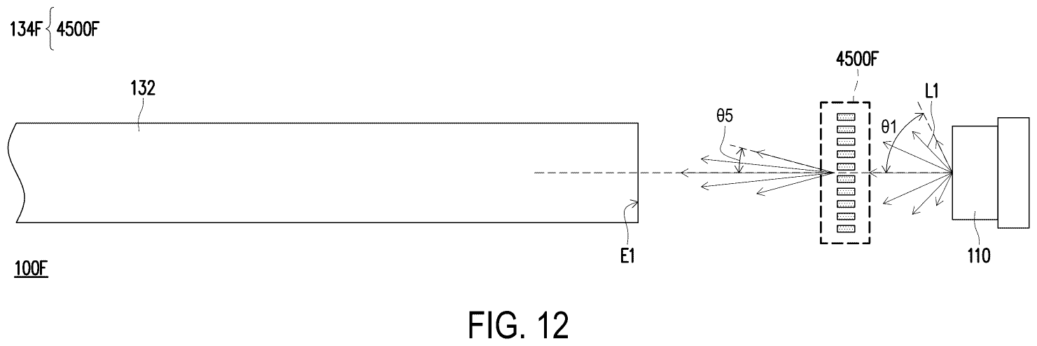

FIG. 12 is a schematic view of the backlight module according to the seventh embodiment of the disclosure. Referring to FIG. 12, a backlight module 100F is similar to the backlight module 100 in FIG. 4, and the main difference thereof is that in this embodiment, a viewing angle control unit 134F includes a viewing angle controller 4500F. The viewing angle controller 4500F may be formed by a plurality of light absorption layers and a plurality of light transmissive layers being alternately arranged along an arrangement direction, the arrangement direction is, for example, perpendicular to the light exit surface O, and the light absorption layer extends in a direction parallel to the first light incident surface E1 and the light exit surface O, for example. The viewing angle controller 4500F is disposed between the first light source module 110 and the light guide plate 132. In the embodiment, a divergence angle θ5 of the first beam L1 after passing through the viewing angle controller 4500F<the divergence angle θ1.

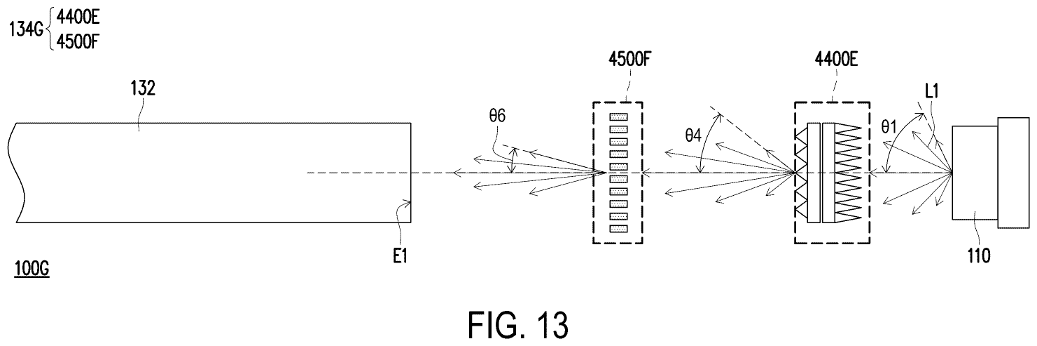

FIG. 13 is a schematic view of the backlight module according to the eighth embodiment of the disclosure. Referring to FIG. 13, a backlight module 100G is similar to the backlight module 100E in FIG. 11 or the backlight module 100F in FIG. 12, and the main difference thereof is that in this embodiment, the viewing angle control unit 134G includes the collimator 4400E and the viewing angle controller 4500F. The collimator 4400E is disposed between the first light source module 110 and the light guide plate 132. The viewing angle controller 4500F is disposed between the collimator 4400E and the light guide plate 132. In the embodiment, a divergence angle θ6 of the first beam L1 after passing through the viewing angle controller 4500F<the divergence angle θ4<the divergence angle θ1.

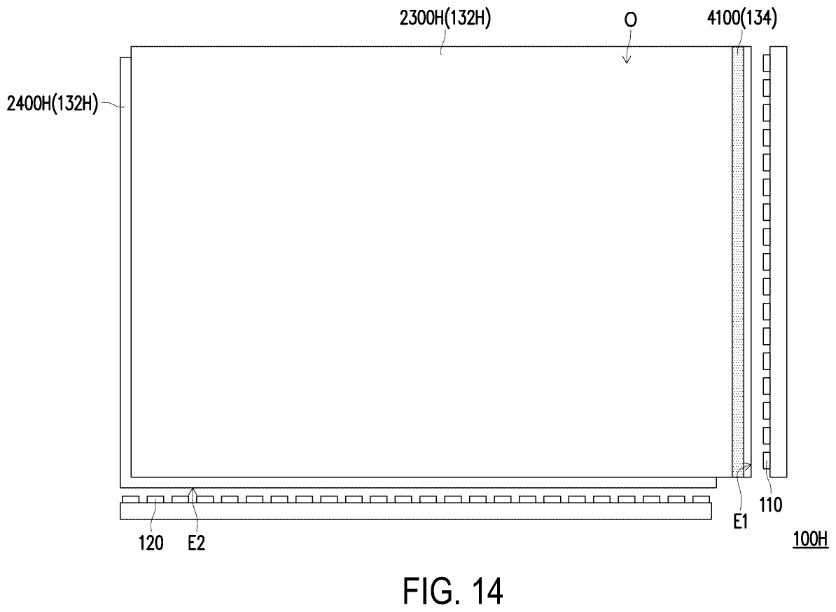

FIG. 14 is a schematic view of the backlight module according to a ninth embodiment of the disclosure. Referring to FIG. 2 and FIG. 14, a backlight module 100H is similar to the backlight module 100 in FIG. 2, and the main difference thereof is that in this embodiment, the light guide plate 132H includes a first light guide plate 2300H and a second light guide plate 2400H. The first light incident surface E1 and the light exit surface O are located on the first light guide plate 2300H. The second light incident surface E2 and the bottom surface B are located on the second light guide plate 2400H. The viewing angle control unit 134 is disposed on the first light guide plate 2300H and is adjacent to the first light source module 110 or is disposed between the first light incident surface E1 and the first light source module 110. The first microstructure 2100 is disposed on a surface of the first light guide plate 2300H. The second microstructure 2200 is disposed on the bottom surface B of the second light guide plate 2400H.

Based on the above, in the backlight module and the display device using the backlight module according to an embodiment of the disclosure, the viewing angle control unit is disposed on the light guide plate and adjacent to the first light source module or disposed between the first light incident surface of the light guide plate and the first light source module. Therefore, when the system is in the sharing mode, the second light source module is turned on, and the divergence angle of the beam emitted by the second light source module remains substantially unchanged during the transmission process. In contrast, when the system is in the anti-peeping mode, the first light source module is turned on, and the divergence angle of the beam emitted by the first light source module is effectively reduced by the viewing angle control unit. In this way, the backlight module/the display device can produce the effect of switchable viewing angles under the design of low system thickness and weight. Moreover, the beam (most of the beam) emitted by the second light source module is not transmitted to the viewing angle control unit during the transmission process, so that the light output angle of the system is larger in the sharing mode, thereby a better experience is provided for the viewer.

In summary, in the backlight module and the display device using the backlight module according to an embodiment of the disclosure, the backlight module includes the first light source module, the second light source module, and the light guide module. The light guide module includes the light guide plate and the viewing angle control unit. In the embodiment, the viewing angle control unit is disposed on the light guide plate and adjacent to the first light source module or disposed between the first light incident surface of the light guide plate and the first light source module. Therefore, when the system is in the sharing mode, the second light source module is turned on, and the divergence angle of the beam emitted by the second light source module remains substantially unchanged during the transmission process. In contrast, when the system is in the anti-peeping mode, the first light source module is turned on, and the divergence angle of the beam emitted by the first light source module is effectively reduced by the viewing angle control unit. Therefore, in the anti-peeping mode, the light energy of the system can be maintained in the center of the viewing angle. In this way, the backlight module/the display device can produce the effect of switchable viewing angles under the design of low system thickness and weight. Furthermore, the main beam (most of the beam) emitted by the second light source module is not transmitted to the viewing angle control unit during the transmission process, so that the light output angle of the system is larger in the sharing mode, thereby a better experience is provided for the viewer.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module comprising a first light source module, a second light source module, and a light guide module, wherein
the light guide module comprises a light guide plate and a viewing angle control unit, wherein the light guide plate has a plurality of first microstructures, a plurality of second microstructures, a first light incident surface, a second light incident surface, a light exit surface, and a bottom surface, the light exit surface is opposite to the bottom surface, the first light source module is disposed corresponding to the first light incident surface, the second light source module is disposed corresponding to the second light incident surface, and an included angle between the first light incident surface and the second light incident surface is greater than or equal to 60 degrees and less than or equal to 120 degrees, wherein
the viewing angle control unit is at least disposed on the light exit surface and the bottom surface of the light guide plate and is adjacent to the first light source module or is disposed between the first light incident surface and the first light source module, a first reflective surface of each of the plurality of first microstructures faces the first light incident surface, a second reflective surface of each of the plurality of second microstructures faces the second light incident surface, the first reflective surface and the bottom surface have a first included angle, the second reflective surface and the bottom surface have a second included angle, and the first included angle is not equal to the second included angle.

2. The backlight module according to claim 1, wherein the plurality of first microstructures and the plurality of second microstructures are disposed on the bottom surface, each of the plurality of first microstructures further comprises a first side reflective surface, each of the plurality of second microstructures further comprises a second side reflective surface, the first side reflective surface and the bottom surface have a third included angle, the second side reflective surface and the bottom surface have a fourth included angle, the fourth included angle is equal to the first included angle, and the third included angle is equal to the second included angle.

3. The backlight module according to claim 1, wherein the viewing angle control unit is disposed on the light exit surface and the bottom surface of the light guide plate, and the viewing angle control unit comprises a light absorption layer, wherein a ratio of a thickness of the light guide plate to a width of the light absorption layer is less than or equal to 0.5.

4. The backlight module according to claim 1, wherein the viewing angle control unit is disposed on the light exit surface and the bottom surface of the light guide plate, and the viewing angle control unit comprises a light absorption layer and a light transmissive layer, wherein the light transmissive layer is disposed between the light absorption layer and the light guide plate, wherein
0≤a refractive index of the light guide plate-a refractive index of the light transmissive layer≤0.4.

5. The backlight module according to claim 1, wherein the viewing angle control unit comprises a plurality of microstructures, wherein
the plurality of microstructures are formed in a prism shape or a semi-cylindrical shape, and the plurality of microstructures extend along a direction parallel to the first light incident surface.

6. The backlight module according to claim 1, wherein the viewing angle control unit comprises a collimator, wherein
the collimator is disposed between the first light source module and the light guide plate, wherein the collimator comprises a plurality of first prism structures, and top corners of the plurality of first prism structures face toward or face away from the first light incident surface.

7. The backlight module according to claim 6, wherein the collimator comprises the plurality of first prism structures and a plurality of second prism structures, and the plurality of top corners of the plurality of first prism structures face away from top corners of the plurality of second prism structures.

8. The backlight module according to claim 1, wherein the viewing angle control unit comprises a viewing angle controller, wherein
the viewing angle controller is disposed between the first light source module and the light guide plate.

9. The backlight module according to claim 1, wherein the viewing angle control unit comprises a collimator and a viewing angle controller, wherein
the collimator is disposed between the first light source module and the light guide plate; and
the viewing angle controller is disposed between the collimator and the light guide plate.

10. The backlight module according to claim 1, wherein
the light guide plate comprises a first light guide plate and a second light guide plate, the first light incident surface and the light exit surface are located on the first light guide plate, the second light incident surface and the bottom surface are located on the second light guide plate, the viewing angle control unit is disposed on the first light guide plate and is adjacent to the first light source module or is disposed between the first light incident surface and the first light source module, the plurality of first microstructures are disposed on a surface of the first light guide plate, and the plurality of second microstructures are disposed on the bottom surface of the second light guide plate.

11. A display device comprising a backlight module and a display panel, wherein
the backlight module is the backlight module according to claim 1; and
the display panel is disposed on the backlight module.
